(19) United States
(12) Patent Application Publication
(10) Pub. No.: US 2007/0174600 A1
(43) Pub. Date: Jul. 26, 2007

(54) Interface for communicating physical presence requests

(75) Inventors: Mark Williams, Kirkland, WA (US); Paul England, Bellevue, WA (US); Xian Ke, Bellevue, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/292,768

(22) Filed: Dec. 2, 2005

(51) Int. Cl. G06F 9/00

(52) U.S. Cl. 713/1

(57) ABSTRACT

In order to facilitate the execution of a command in a pre-OS environment, functionality is provided in the OS environment which allows information regarding a requested command to be communicated to the pre-OS environment. A user request for a command is received, and the user is given information regarding the procedure for execution of the command. The OS communicates to the pre-OS environment certain information, for example by writing to specific memory locations accessible by the pre-OS environment. When the pre-OS environment is activated, the information is used in order to facilitate the user's execution of the command. Information can be transmitted back to the OS, for presentation to the user or further action by the pre-OS environment.

### BACKGROUND

Security on a computer system is of paramount importance. Security solutions which reduce or solve security problems are of two types: purely software solutions, and those which involve a hardware component.

Software-only solutions to security problems have systemic vulnerabilities. Generally, software solutions utilize a shared memory space and rely on the operating system to manage physical memory. Since security software functions within the confines of the operating system, security software is susceptible to compromise due to any vulnerabilities of the operating system. Software security solutions may leave important data vulnerable to arbitrary access by an adversary via such vulnerabilities, compromising security. The security software itself also may be vulnerable to modification or may contain inherent vulnerabilities.

Hardware-based solutions to security problems can avoid these vulnerabilities of software solutions. A hardware-based security solution requires accessing memory space that is more tightly controlled and defined. Security hardware generally exists “below” the operating system in the layered model of computer systems, so its overall attack surface is reduced. And, hardware is naturally less flexible than software in terms of ease of modification.

In order to provide enhanced security in a computer device, the hardware-based solution of a hardware “trusted platform module” (TPM) embedded in a computer motherboard has been proposed. The TPM has been defined and developed by the Trusted Computing Group (TCG), (www.trustedcomputinggroup.org) a not-for-profit industry-standards organization with numerous industry members. Specifications for TPM are available from the Trusted Computing Group.

TPM is a microchip designed to provide some basic security-related functions to the software utilizing it. In one incarnation, TPM provides protected capabilities, integrity measurement, and integrity reporting. Protected capabilities are commands which must be used to access locations in memory in which sensitive data can be stored. Integrity measurements measure the integrity of the device the TPM is monitoring, and integrity reporting provides those measurements in a way which assures the integrity of the measurements. The TPM communicates with the rest of the system via a hardware bus.

In order to authorize certain commands to the TPM, “physical presence” may be required. Physical presence is a condition in which the TPM verifies that a command is being issued by an actual operator present at the device in some way, rather than being issued by, for example, by a software virus or an adversary from a location remote from the device. TPM commands that require so-called “physical presence” include management functionality necessary to opt into (turn on) the TPM, certain protected commands, and commands to clear the TPM if the machine is decommissioned.

In current TPM implementation, in order to satisfy the physical presence requirement by execution by the physically-present user of a command, such commands requiring physical presence cannot be issued via the operating system. If the command were executable from the operating system, malicious software could emulate the physically-present operator and defeat the physical-presence requirement. In this way, viruses or other malicious software running on the operating system (“OS”) cannot emulate that physically-present operator (e.g. by emulating a button press or confirmation dialog input).

Thus, in a current TPM implementation, physical presence verification via the BIOS (basic input/output system) is used. A BIOS or other pre-operating-system (“pre-OS”) environment is a software program with limited and basic functionality controls a computer system upon start-up. The pre-OS environment may either be used by the user to perform specific limited functionality, or (generally in the absence of any specific user request to the contrary) invokes the OS, which then is used to control the computer system. The limitations of BIOS or a similar pre-OS environment make it harder to compromise via malicious software. Thus, it is much more difficult to emulate a physically-present operator if commands are limited to the BIOS (basic input/output system) or similar pre-OS environments. A flag (“physicalPresence”) is set in TPM when the physical presence of the owner has been verified.

Allowing sensitive TPM commands to be executed only in the BIOS after successful physical authorization minimizes the possibility that malicious code can execute TPM commands in the absence of a physically-present operator. One way in which such sensitive TPM commands can be executed in the BIOS is by requiring the user to enter the BIOS (often through a button sequence at startup) and select from a BIOS menu or respond to confirmation dialog displayed in the BIOS. Thus, the BIOS is the means by which a user can turn on the TPM and perform other TPM functions.

One problem with allowing TPM commands to be executed only in the BIOS is that the majority of computer users are unfamiliar with the BIOS environment. Additionally, the BIOS or other pre-OS environment present on different computer systems can differ dramatically among the various computer manufacturers. Thus, uniform directions regarding how to turn on the TPM or execute a TPM command cannot be provided, as the BIOS menu or confirmation dialog are different from system to system.

According to a current TPM scheme, a TPM is shipped in an off state by default, and must be turned on before it can be used. As noted, this leads to a user experience that requires an inexperienced computer user to configure their BIOS, which may look radically different from any other BIOS that the user has seen or read about. In order to initialize the TPM, then, a user needs to be able to understand and configure a platform's BIOS. This is a significant deterrent to the mass deployment of trusted platforms, especially across heterogeneous platforms.

### SUMMARY

In some embodiments, a user, with the operating system environment active, requests that one or more secure commands be performed. Information regarding the command(s) is stored in a location accessible to the a pre-operating-system environment. Then, when the pre-operating-system environment is transitioned to, the information is read from storage, and used in order to assist the user in verifying physical presence and executing the command(s).

Only some embodiments of the invention have been described in this summary. Other embodiments, advantages and novel features of the invention may become apparent from the following detailed description of the invention when considered in conjunction with the drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram of an exemplary computing environment in which aspects of the invention may be implemented;

FIG. 2 shows a flow diagram of the execution of a secure command requiring physical presence using a technique according to one embodiment of the invention;

FIG. 3 shows a flow diagram of operations in the operating system environment according to some embodiments of the invention;

FIG. 4 shows a flow diagram of operations in the pre-OS environment according to some embodiments of the invention; and

FIG. 5 is a block diagram of a system according to one embodiment of the present invention.

### DETAILED DESCRIPTION

Exemplary Computing Environment

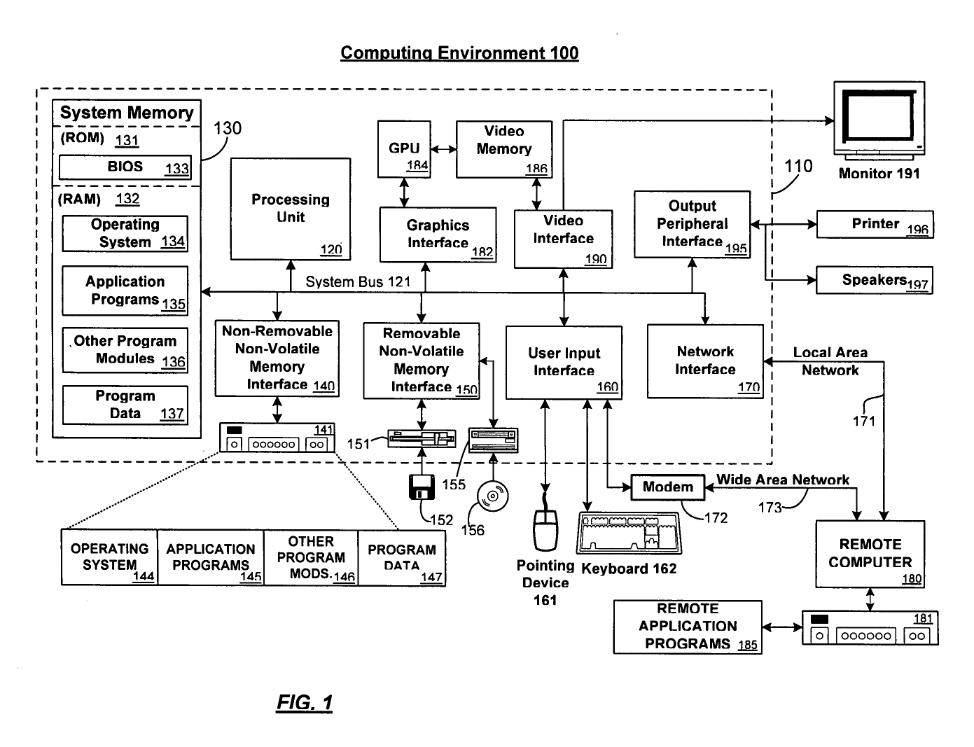

FIG. 1 shows an exemplary computing environment in which aspects of the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary computing environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, embedded systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The processing unit 120 may represent multiple logical processing units such as those supported on a multi-threaded processor. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus). The system bus 121 may also be implemented as a point-to-point connection, switching fabric, or the like, among the communicating devices.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Interface for Communicating Physical Presence Requests

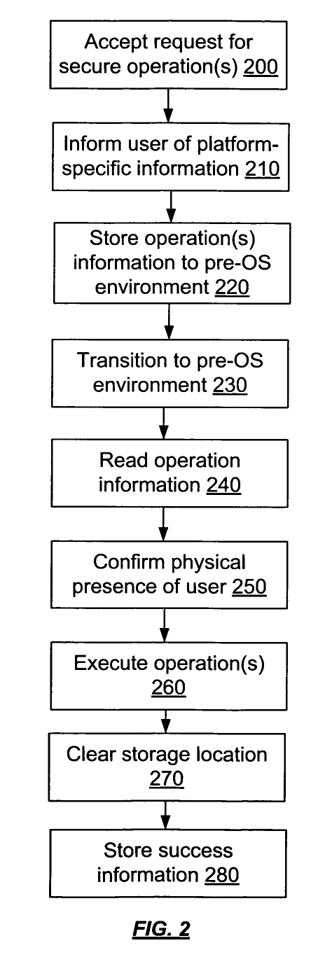

According to some embodiments of the present invention, a physical presence interface is established by which the operating system can assist the user in establishing physical presence. FIG. 2 shows a flow diagram of the execution of a secure command requiring physical presence using a technique according to one embodiment of the invention.

As shown in FIG. 2, in a first step 200, the operating system (OS) accepts a user request for a secured operation that requires physical presence. In some embodiments, in a step 210, the OS informs the user of the platform-specific procedure that must take place to successfully execute the secured operation. For example, the procedure may require the user to enter the BIOS or other pre-OS environment using a specific command at startup, and then to go to a specific menu and make a specific selection. The operating system will inform the user of some or all platform-specific information necessary to allow the secured operation to be successfully executed. (While the description will hereinafter describe the BIOS as handling secured operations, as described above according to the present invention the pre-OS environment which is used for secure operations may be another pre-OS environment, such as any pre-OS system which controls resources not available to the operating system. Additionally, while the secured operation will hereinafter be described as a TPM operation, any secure operation handled by a pre-OS environment where that operation requires physical presence may be used with the present invention.)

In addition to providing information to the user, in one embodiment, the OS communicates the requested TPM operation to the BIOS, step 220. This is done through an interface which stores information in a location accessible to the BIOS or otherwise communicates with the BIOS. One such interface, the one used in some embodiments of the present invention, is the Advanced Configuration and Power Interface (ACPI).

ACPI is an industry specification co-developed by several computer hardware and software manufacturers. ACPI establishes industry-standard interfaces for OS-directed configuration and power management on laptops, desktops, and servers. The Advanced Configuration and Power Interface (ACPI) specification was developed to establish industry common interfaces enabling robust operating system (OS)-directed motherboard device configuration and power management of both devices and entire systems. For example, the ACPI configuration allows an operating system to transition a device into a “sleeping” state including initiating power management operations which, without ACPI, would be the exclusive domain of the BIOS or other pre-OS environment.

In embodiments of the invention in which ACPI is used to communicate with the BIOS, the OS's ACPI handler stores data regarding the requested TPM operation in a location accessible to the BIOS environment (e.g. CMOS, Flash ROM, TPM NVRAM, etc.).

After storing the TPM operation information in step 220, the OS reboots or shuts down the platform, step 230. This rebooting or shut-down is a user-visible event and transitions the platform to the BIOS environment. In step 240, the BIOS reads the OS's TPM operation request information from its stored location. In step 250, the BIOS confirms the physical presence of the user. When the physical presence of the user has been confirmed, the BIOS executes the requested TPM operation(s) in step 260. The operation to execute is determined at least in part by consulting the stored TPM operation request. In some embodiments, other information is used to determine which TPM operation(s) to perform, such as user input data. In step 270, the storage location containing the TPM operation request information is cleared.

In step 280, the BIOS communicates execution information, including any response from the TPM operation(s) performed, back to the OS. As in step 220, this can be accomplished using ACPI. In some embodiments, the response comprises a success code if the operation was confirmed and executed; a failure code if the user failed to issue a confirmation; or a TPM command error. In other embodiments some or all of these can be communicated as a response, or additional information can be communicated. In some embodiments, no information is communicated back to the OS.

When the OS loads, in some embodiments, the OS takes action based on the information received in step 280. This action is in one embodiment providing post-execution guidance to the user (e.g. by a display of information), based on the execution information regarding the success or failure of the TPM operations. In other embodiments, other actions in addition to or instead of such communication is performed by the OS. In some embodiments, no action is taken based on the communicated information or, as detailed above, no information is communicated back to the OS.

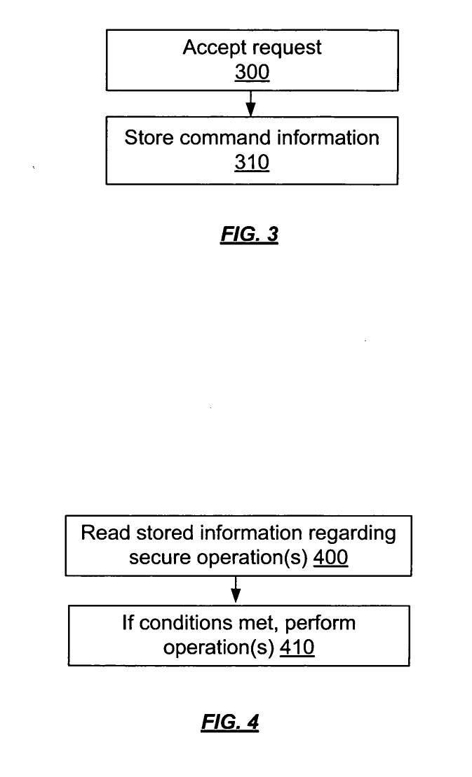

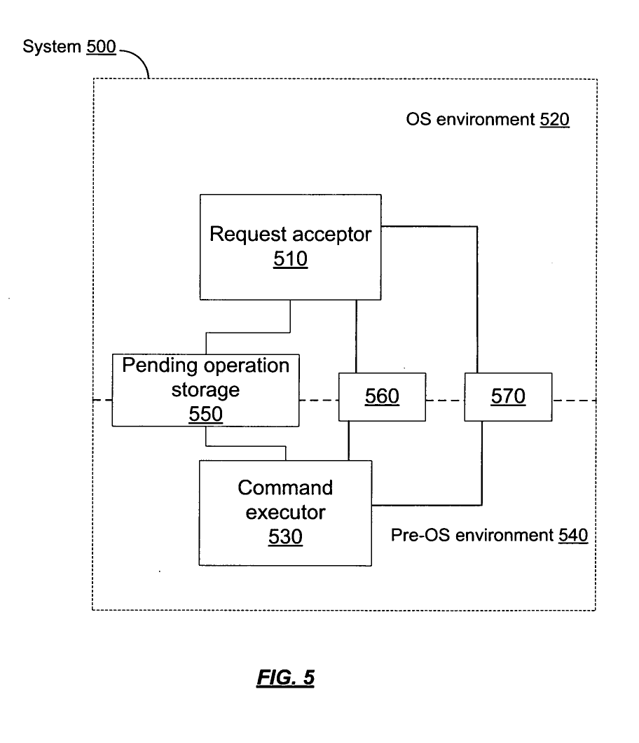

FIG. 2 displays steps performed in the operating system environment along with steps performed in the pre-OS environment. FIGS. 3 and 4 provide flow diagrams of the operations in the operating system environment (FIG. 3) and the pre-operating system environment (FIG. 4) according to some embodiments of the invention. As shown in FIG. 3, in step 300, a request for a secure (pre-OS) operation(s) is accepted. This request, as described above, may be a result of a user's request to perform the pre-OS operation. However, in some embodiments, a program may initiate this request. For example, if the user executes a set-up program, the set-up program may request the secure pre-OS operation. Such a request is received in the OS environment (in which the program is running) for execution in the pre-OS environment. In step 310, command information regarding the secure operation(s) is stored.

As shown in FIG. 4, in step 400, stored information regarding the secure operation(s) is read from a storage location. In step 410, if all of a set of pre-command conditions have been met, then the operation(s) are performed. The pre-command conditions may include a condition satisfied only if the user has indicated physical presence. This may be implicit in another condition—for example, if the user must press a specific key (e.g. [F10]) in order to approve the execution of a command, then the pressing of that key is a condition which also implies that the user is physically present. In some embodiments, as described below, a dialog is presented to the user which indicates how the user can satisfy one or more of these pre-command conditions under the pre-OS environment.

Security Considerations

As described above, at the operating-system-level, security vulnerabilities exist which are not present at the pre-OS level. Thus, no assumption should be made by the BIOS or other pre-OS system responsible for verifying physical presence and performing TPM operations that a request for a TPM operation received from the OS (as in step 220) is valid. There is always the possibility that a TPM operation was requested by malicious software without knowledge of the platform user.

Because this assumption cannot be made, the pre-OS environment verifies the physical presence of the user and confirms that this physically-present user in fact requested the execution of the operation. This also conforms the operation of the pre-OS environment to the TPM standard (or possibly to other standards being used for secure operations).

In some embodiments, the pre-OS environment (e.g. BIOS) achieves this confirmation via a pre-OS dialog. The dialog is implemented such that the user can understand at a high level the security implications of the operation and must actively choose to execute the operation (e.g. the default should not be to confirm the operation). If the request is rejected by the physically-present user, the pre-OS environment clears the request so that the user is not prompted to confirm again on the next reboot.

There also exists the possibility that malicious software can attempt to launch a denial of service attack on the platform by repeatedly invoking the interface which submits TPM operation requests in step 220. In order to avoid damage from type of attack, the platform manufacturer may structure the platform so that such abuse will not cause irreparable damage to the platform (e.g. by burning out flash memory used to store the requests), or by structuring the platform so that if such irreparable damage is caused, it will not imperil the security established by TPM or any other system by which secure operations are handled.

In one embodiment, the platform storage implementing the communication of physical presence requests includes: pending operation information storage for storing the pending operation request submitted by the OS; acted-upon operation information storage for storing the most recent operation request acted upon by the BIOS; and operation response information storage for storing the most recent operation response acted upon by the BIOS. In one embodiment, the storage is four bits for the pending operation information storage, four bits for the acted-upon operation information storage; and seven bits for operation response information storage. The storage size for operation response information storage assumes that there exist at most one hundred and twenty-eight possible operation responses. In the TPM specification, version 1.2, this would be sufficient, as there exist one hundred and three possible operation responses consisting of ninety-nine TPM fatal errors and four TPM non-fatal errors. In one embodiment, two additional operation responses are included which are specific to the physical presence interface. These are User Abort (indicating that the user has decided not to perform the requested operations) and BIOS failure, indicating a problem with the BIOS behavior.

FIG. 5 is a block diagram of a system according to one embodiment of the present invention. As shown in FIG. 5, a system 500 includes a request acceptor 510, which functions in the OS environment 520, and a command executor 530, which functions in pre-OS environment 540. Additionally, pending operation information storage 550 exists which is accessible by both request acceptor 510 and command executor 530. The request acceptor 510 stores information regarding the operation or operations the user requests from the operating system in the pending operation information storage in the pending operation information storage 550, where it can be read by command executor 530 when the pre-OS system is operative.

Additionally, as described above, additional storage accessible by request acceptor 510 and command executor 530 is included in system 500 according to some embodiments of the invention, such as operation response information storage 560 and user information storage 570. The operation response information storage 560 stores response information from the execution of the commands, as described above, and the user information 570 stores information about the user which can be used by the command executor 530, for example, by presenting information to the user in a preferred language or by otherwise changing presentation of information to the user according to the user preferences or information contained in user information storage 570.

Physical Presence Interface Functions

In some embodiments, to implement the physical presence interface, the following functions are exposed by the pre-OS system:
Get Physical Presence Interface Version: This function returns the version of the physical presence interface supported by the pre-OS system.
Submit Secure Operation Request to Pre-OS Environment: This function allows the OS to submit a request for a secure operation to be executed in the pre-OS environment. This request is the input from the OS to the pre-OS environment.

In some embodiments, the pre-OS environment returns a value of 0, 1, or 2 in response to this function. If 0 is returned, the requested operation can be read and acted upon by the BIOS once the transition to the pre-OS environment takes place (e.g. after the platform has restarted). The OS expects that the pre-OS environment verifies physical presence and confirms that the physically-present user in fact requested the execution of the TPM operation. If 1 is returned, the BIOS does not support the operation request. For example, the implementation of the operation may be optional or vendor-specific. If 2 is returned, the BIOS is otherwise unable to read and act upon the request. For example, platform-specific security protections may exist to prevent burnout of the storage location for the TPM operation. In one embodiment, the OS may call this function multiple times before transitioning to the pre-OS environment. However, only the last submitted request is valid.

The OS may submit a TPM operation request of value 0 to clear any previous requests.

Get Pending Secure Operation Requested By the OS: This function returns the pending secure operation that was previously requested, if any. This function allows the OS to accurately determine platform state. One use case is to ensure that a previously-submitted operation request is not overwritten.

In some embodiments, in addition to data regarding a pending TPM operation requested, an additional execution information value is returned to indicate the success or failure of the operation. In some embodiments, if a specific value is returned as the pending TPM operation, it indicates that no TPM operation has been requested.

Get Platform-Specific Action to Transition to Pre-OS Environment: This function allows the OS to determine the platform-specific action that should take place in order to transition to the BIOS for execution of a requested TPM operation. This function provides platform manufacturers the flexibility to vary how their platforms meet TCG's physical presence requirements, while minimizing the impact of these platform changes on OS applications.

In some embodiments, if 0 is returned, no action is required. If 1 is returned, the OS must shut down the machine to execute the requested TPM operation. A physically-present user restarts the machine. If 2 is returned, the OS must cause a warm reboot of the machine. If 3 is returned, an OS-specific action can take place. For example, instructions can be displayed for the physically-present user to consult platform documentation. The OS may specify additional requirements to determine the exact behavior for this return value.

Return Secure Operation Response to OS Environment: This function allows the BIOS to communicate the response to the most recent secure operation request it acted upon. The function returns both the most recent request and the response to that request.

Where the OS can query the TPM directly to determine whether a request was indeed fulfilled, that query may be preferred, and this function's return values used only for troubleshooting failures and auditing purposes. This is because, for some platforms, the return values for this function may not be reliable. For example, if multiple OS's exist on the platform, the request-response values cannot be correlated to any particular OS. Furthermore, there is no guarantee that the response is available to the OS that originated the request; another OS may submit a new request, overwriting the response to the previous request.

In some embodiments, three integer values are returned in response to this function. If one is returned as the first integer, the BIOS is unable to return meaningful information due to an internal failure. In this case, the second and third integers are undefined.

Otherwise, if zero is returned as the second integer, no previously-requested TPM operations exist and hence no response exists. In this case, the third integer is undefined.

If one is not returned as the first integer and if a value greater than zero is returned as the second integer, that value is the most recent TPM operation request seen by the BIOS. The third integer then represents the response to the operation request.

If the response (third integer) returned is zero, then the requested TPM operation was confirmed and successfully executed in the pre-OS environment. A response value from 1 to 0x00000FFF inclusive corresponds to a TPM error code. If 0xFFFFFFF0 is returned as the response, the user failed to confirm the TPM operation request. If 0xFFFFFFF1 is returned as the response, then a BIOS failure prevented the successful execution of the requested TPM operation (e.g. invalid TPM operation request, BIOS communication error with the TPM).

Thus, a return value of {1, 0, 0} indicates that a BIOS internal failure prevented the function from retrieving meaningful information. A return value of {0, 0, 0} indicates that no previously-requested TPM operations exist and hence no response exists. A return value of {0, 6, 0} indicates that the last TPM operation request to enable and activate the TPM succeeded. A return value of {0, 6, 0xFFFFFF0} indicates that the last TPM operation request to enable and activate the TPM was rejected by the physically-present user in the pre-OS environment. And a return value of {0, 6, 0xFFFFFFF1} indicates that the last TPM operation request to enable and activate the TPM failed to execute successfully due to an internal BIOS error.

Submit User Information: This function allows the OS to communicate user information to the BIOS. This user information can be used by the BIOS in order to provide the best user experience to the user.

For example, in some embodiments, this function can be used to submit the user's preferred language to the BIOS. Providing this function and/or using the information is optional for the pre-OS environment. Because EFI BIOSes include a variable (the Lang variable) which encapsulates the user's preferred language information, the provision of user's preferred language via this function should be deprecated.

If this function is available, the OS queries the preferences of the current user, and submits this information to the pre-OS environment. For example, where this is used to provide language information to the BIOS, in some embodiments the OS queries the current user's preferred language and submits this information to the BIOS using the 2-character language code defined by the ISO-639-1 standard. In some embodiments, if 0 is returned, the language code can be read and acted upon by the BIOS once the transition to the pre-OS environment takes place (e.g. after the platform has restarted). The OS expects that the pre-OS environment displays the confirmation dialog in the user's preferred language. If 1 is returned, the BIOS does not support the language indicated. For example, the BIOS has not localized the confirmation dialog to that language. If 2 is returned, the BIOS is otherwise unable to read and act upon the language code. In such cases, the OS may call this function multiple times before transitioning to the pre-OS environment and the last submitted language code is valid. In this way, a user's second-choice language may be submitted if the first-choice language is unavailable.

Support for this function requires additional platform storage. The minimum additional platform storage required depends on the number of languages supported by the BIOS. For example, if the BIOS is localized for 32 languages, 5 additional bits are required.

Requesting Secure Operations

As detailed above, a function allows the OS to submit a request for a secure operation to the pre-OS environment. In one embodiment, only one request can be submitted in this way. This limits the amount of platform space that the pre-OS dedicates to the physical presence interface. However, while in some embodiments such a request may only specify a single secure operation, in some other embodiments, a compound requests may be indicated by the value submitted to the pre-OS environment.

For example, in one embodiment, the secure operation(s) requested is indicated by an integer which is submitted by the OS (using the Submit Secure Operation Request to Pre-OS Environment function). One value for the integer indicates that a specific secure operation has been requested. Another value, however, may correspond to a sequence of secure operations. For example, according to some embodiments in which the secure operations are TPM operations, the value for the integer (“Operation Request Value”) corresponds to operations as specified in Table 1:

TABLE 1
Corresponding Operations for Specified Values

| Operation | | |
|---|---|---|
| Request Value | Operation Name | Related TPM Commands(s) |
| 0 | No operation | No operation |
| 1 | Enable | TPM_PhysicalEnable |
| 2 | Disable | TPM_PhysicalDisable |
| 3 | Activate | TPM_PhysicalSetDeactivated, with |
| | | state = FALSE |
| 4 | Deactivate | TPM_PhysicalSetDeactivated, with |
| | | state = TRUE |
| 5 | Clear | TPM_ForceClear |
| 6 | Enable + | TPM_PhysicalEnable |
| | Activate | TPM_PhysicalSetDeactivated, with |
| | | state = FALSE |
| 7 | Deactivate + | TPM_PhysicalSetDeactivated, with |
| | Disable | state = TRUE |
| | | TPM_PhysicalDisable |
| 8 | SetOwnerInstall_True | TPM_SetOwnerInstall, with state = |
| | | TRUE |
| 9 | SetOwnerInstall_False | TPM_SetOwnerInstall, with state = |
| | | FALSE |
| 10 | Enable + | TPM_PhysicalEnable |
| | Activate + | TPM_PhysicalSetDeactivated, with |
| | SetOwnerInstall_True | state = FALSE |
| | | TPM_SetOwnerInstall, with state = |
| | | TRUE |
| 11 | Deactivate + | TPM_PhysicalSetDeactivated, with |
| | Disable + | state = TRUE |
| | SetOwnerInstall_False | TPM_PhysicalDisable |
| | | TPM_SetOwnerInstall, with state = |
| | | FALSE |
| 12 | SetTempDeactivated | TPM_SetTempDeactivated, with |
| | | tag!=TPM_TAG_REQ_AUTH1_COMMAND |
| | | (so that operator authorization not used) |
| | | The implementation of this operation is |
| | | OPTIONAL |
| 13 | SetOperatorAuth | TPM_SetOperatorAuth, with operatorAuth |
| | | prompted by the BIOS |
| | | The implementation of this operation is |
| | | OPTIONAL |
| 14 | Clear + Enable + | TPM_ForceClear |
| | Activate | TPM_PhysicalEnable |
| | | TPM_PhysicalSetDeactivated, with |
| | | state = FALSE |
| >= 128 | Vendor Specific | TPM commands mapping to vendor specific |
| (0x80) | Operation | operation |

As can be seen from Table 1, a value of 1 corresponds to the enabling of the TPM. A value of 3 corresponds to the activation of the TPM. Thus, these values can be used in order to request the corresponding operations. If, however, both enabling and then activation are required, both of these operations (in sequence) can be requested with a request value of 6. Thus, by enumerating the most likely sequences of commands and mapping them to unique operations, all standard functionality involving physical presence can be carried out within one machine reboot.
Pre-OS Environment Dialog

As discussed above, in some embodiments, the pre-OS environment presents a dialog corresponding to the requested operation in order to help the user understand what operations are going to be performed and what actions the user must take to perform (or to stop) the operations.

This may be implemented by having the pre-OS environment store dialogs which correspond to each of the operation request values in Table 1. These dialogs are specific to the pre-OS environment, because different pre-OS environments may require different user actions to execute the operation. Each operation request is mapped to a dialog which is presented to the user to allow the user to accept or reject the operations. For example, Table 2, provides dialogs according to one embodiment of the invention, each dialog corresponding to one of the operation request values in Table 1:

TABLE 2
Dialogs for Selected Operation Request Values

| Operation | | |
|---|---|---|
| Request Value | Operation Name | Confirmation Dialog |
| 1 | Enable | “A configuration change was requested to |
| | | enable this computer's TPM (Trusted Platform Module). |
| | | Press [F10] to enable the TPM. |
| | | Press ESC to reject this change request and continue.” |
| 2 | Disable | “A configuration change was requested to |
| | | disable this computer's TPM (Trusted Platform Module). |
| | | WARNING: Doing so might prevent security applications |
| | | that rely on the TPM from functioning as expected. Press |
| | | [F10] to disable the TPM. Press ESC to reject this change |
| | | request and continue.” |
| 3 | Activate | “A configuration change was requested to |
| | | activate this computer's TPM (Trusted Platform Module). |
| | | Press [F10] to activate the TPM. |
| | | Press ESC to reject this change request and continue.” |
| 4 | Deactivate | “A configuration change was requested to |
| | | deactivate this computer's TPM (Trusted Platform |
| | | Module). WARNING: Doing so might prevent security |
| | | applications that rely on the TPM from functioning as |
| | | expected. Press [F10] to deactivate the TPM. |
| | | Press ESC to reject this change request and continue.” |
| 5 | Clear | “A configuration change was requested to |
| | | clear this computer's TPM (Trusted Platform Module). |
| | | WARNING: Clearing erases information stored on the |
| | | TPM. You will lose all created keys and access to data |
| | | encrypted by these keys. Press [F12] to clear the TPM. |
| | | Press ESC to reject this change request and continue.” |
| 6 | Enable + | “A configuration change was requested to |
| | Activate | enable and activate this computer's TPM (Trusted Platform |
| | | Module). NOTE: This action will switch on the TPM. |
| | | Press [F10] to enable and activate the TPM. |
| | | Press ESC to reject this change request and continue.” |
| 7 | Deactivate + | “A configuration change was requested to |
| | Disable | deactivate and disable this computer's TPM (Trusted |
| | | Platform Module). NOTE: This action will switch off the |
| | | TPM. WARNING: Doing so might prevent security |
| | | applications that rely on the TPM from functioning as |
| | | expected. Press [F10] to deactivate and disable the TPM. |
| | | Press ESC to reject this change request and continue.” |
| 8 | SetOwnerInstall_True | “A configuration change was requested to |
| | | allow a user to take ownership of this computer's TPM |
| | | (Trusted Platform Module). Press [F10] to allow a user to |
| | | take ownership of the TPM. Press ESC to reject this |
| | | change request and continue.” |
| 9 | SetOwnerInstall_False | “A configuration change was requested to |
| | | disallow a user to take ownership of this computer's TPM |
| | | (Trusted Platform Module). Press [F10] to disallow a user |
| | | to take ownership of the TPM. Press ESC to reject this |
| | | change request and continue.” |
| 10 | Enable + | “A configuration change was requested to |
| | Activate + | enable, activate, and allow a user to take ownership of |
| | SetOwnerInstall_True | this computer's TPM (Trusted Platform Module). NOTE: |
| | | This action will switch on the TPM. Press [F10] to enable, |
| | | activate, and allow a user to take ownership of the TPM. |
| | | Press ESC to reject this change request and continue.” |
| 11 | Deactivate + | “A configuration change was requested to |
| | Disable + | deactivate, disable, and disallow a user to take ownership |
| | SetOwnerInstall_False | of this computer's TPM (Trusted Platform Module). |
| | | NOTE: This action will switch off the TPM. WARNING: |
| | | Doing so might prevent security applications that rely on |
| | | the TPM from functioning as expected. Press [F10] to |
| | | deactivate, disable, and disallow a user to take ownership |
| | | of the TPM. Press ESC to reject this change request and |
| | | continue.” |
| 14 | Clear + | “A configuration change was requested to |
| | Enable + | clear, enable, and activate this computer's TPM (Trusted |
| | Activate | Platform Module). NOTE: This action will clear and |
| | | switch on the TPM. WARNING: Clearing erases |
| | | information stored on the TPM. You will lose all created |
| | | keys and access to data encrypted by these keys. Press |
| | | [F10] to clear, enable, and activate the TPM. Press ESC to |
| | | reject this change request and continue.” |

In consideration of the limited space in the BIOS to store text, the confirmations presented in Table 2 attempt to maximize the potential for text reuse while minimizing impact on security and user understanding. Thus, for example, “Press ESC to reject this change request and continue” is part of each of the dialogs, which allows for text reuse of this sentence, saving space. In the embodiment shown above, the key used to confirm the Clear operation differs from the confirmation key used for other operations. This prevents accidental execution of the Clearing operation. Where, as discussed above, the pre-OS can be informed of the user language preference via the Submit User Information function, according to some embodiments, dialogs are provided for each supported language.

The dialog is implemented such that the user can understand at a high level the security implications of the operation and must actively choose to execute the operation (e.g. the default should not be to confirm the operation). If the request is rejected by the physically-present user, the pre-OS environment clears the request so that the user is not prompted to confirm again on the next reboot. In this way, where the user needs to satisfy one or more pre-command conditions, the dialog can be presented to the user in order to guide the user in satisfying the condition. For example, operation request value 14 corresponds to a request to clear, enable, and activate the TPM. In order to do so, according to one pre-OS environment, the user needs to signify assent by pressing the [F10] button. Thus the dialog shown in Table 2 is presented to the user in order to assist the user in understanding how to meet pre-command conditions and indicate consent.

### CONCLUSION

It is noted that the foregoing examples have been provided merely for the purpose of explanation and are in no way to be construed as limiting of the present invention. While the invention has been described with reference to various embodiments, it is understood that the words which have been used herein are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

What is claimed:

1. A method for submitting a pre-operating-system command for execution in a pre-operating-system environment, comprising:
accepting from an operating system environment a request for the execution of said pre-operating-system command; and
storing command information regarding the identity of said pre-operating system command so said command information is accessible to said pre-operating-system environment.

2. The method of claim 1, further comprising:
providing pre-execution guidance to said user regarding how to perform said pre-operating-system command in said pre-operating system environment.

3. The method of claim 1, further comprising:
initiating a transition to the pre-operating-system environment in response to said request from said user.

4. The method of claim 3, said step of initiating a transition comprising:
retrieving from said pre-operating-system environment transition trigger information regarding how to perform said transition; and
acting in a way consistent with said transition trigger information.

5. The method of claim 1, where said request comprises a request for the execution of a series of pre-operating-system commands.

6. The method of claim 1, further comprising:
storing user information regarding characteristics of the user, where said characteristics are relevant to the operation of said pre-operating-system environment.

7. The method of claim 6, where said user information comprises user language preference information.

8. The method of claim 1, where said method further comprises:
upon a transition back to the operating system environment, providing post-execution guidance to said user, where said post-execution guidance is based on execution information stored by said pre-operating-system environment regarding execution of said pre-operating-system command.

9. The method of claim 1, where said step of storing information occurs via an interface exposed by said pre-operating-system environment.

10. A system for executing a pre-operating-system environment command initiated in an operating system environment, said system comprising:
a request acceptor, for accepting a request to perform a pre-operating-system environment command, said request acceptor operable in said operating system environment;
a pending operation information storage, said pending operation information storage operably connected to said request acceptor, said pending operation information storage storing pending operation data regarding said request; and
a command executor, said command executor operably connected to said pending information storage, for executing said pre-operating-system environment command, said command executor operable in said pre-operating system environment.

11. The system of claim 10, further comprising:
an operation response information storage, operably connected to said request executor, storing operation response information regarding said execution of said pre-operating-system environment command.

12. The system of claim 10, further comprising user information storage, said user information storage operably connected to said request acceptor, said user information storage operably connected to said command executor, storing user information regarding a user, said user information stored by said request acceptor; and
where said command executor uses said user information in the execution of said pre-operating-system environment command.

13. The system of claim 12, where said user information comprises language information, and where said command executor displays information to said user in a display language selected from among at least two possible languages, where the choice of said display language is based on said user information.

14. The system of claim 12, where said command executor displays a dialog describing how to execute said pre-operating-system environment command, said system further comprising:
dialog storage, said dialog storage operably connected to said command executor, said dialog storage storing said dialog.

15. A computer-readable medium comprising computer-executable instructions for executing a command in a pre-operating-system environment, said computer-executable instructions for performing steps comprising:
reading stored command information comprising information regarding the identity of said command;
executing said command if all of a set of at least one pre-command conditions have been met.

16. The computer-readable medium of claim 15, where said set of at least one pre-command conditions comprises a condition satisfied only if a user indication of physical presence is received.

17. The computer-readable medium of claim 15, where said step of performing said command comprises:
storing execution information regarding said execution of said command.

18. The computer-readable medium of claim 15, where said step of executing said command comprises:
reading user information; and
presenting information to said user based on said user information.

19. The method of claim 15, where said stored command information comprises information regarding the identity of one or more additional commands, and where said step of executing said command further comprises executing said additional commands.

20. The method of claim 15, where said step of executing said command comprises:
reading a stored dialog corresponding to said command; and
displaying said stored dialog.
